(19) United States
(12) Patent Application Publication
(10) Pub. No.: US 2023/0123278 A1
(43) Pub. Date: Apr. 20, 2023

(54) Object Supporting Device Adapted to be Fixed to a Finger of a User Hand

(71) Applicant: Roberto BUFARINI, PORTORECANATI (IT)

(72) Inventor: Roberto BUFARINI, PORTORECANATI (IT)

(21) Appl. No.: 17/961,947

(22) Filed: Oct. 7, 2022

(30) Foreign Application Priority Data
Oct. 14, 2021 (IT) 102021000026420

(51) Int. Cl. F16M 13/04; G10D 3/173; B43K 23/012

(52) U.S. Cl. CPC F16M 13/04; G10D 3/173; B43K 23/012

(57) ABSTRACT

An object supporting device (1) is provided, which includes a first element (3) adapted to be fixed to a finger (4) of a user's hand, and a second element (5) adapted to be fixed to said first element (3) and able to support said object (2), wherein said first element (3) includes: a) a main body (10), b) at least one band (6) provided with a first end (6a) fixed to said main body (10) and a second free end (6b), opposite said first end (6a), c) a fixing body (7) fixed to said main body (10) and provided with at least one seat (8), wherein each of said at least one seat (8) is adapted to receive and lock in it said second free end (6b) of said corresponding at least one band (6), so that each of said at least one band (6), once fixed in the corresponding seat (8), forms a sort of a ring adapted to be wrapped around said finger (4), and wherein said first element (3) further includes an internally hollow body (9) fixed to said main body (10) arranged substantially along the longitudinal direction of one of said bands (6).

### TECHNICAL FIELD

The present invention refers to an object supporting device, adapted to be fixed to a finger of a user's hand. In particular, the present invention refers to such an object supporting device for supporting a guitar plectrum, small pencils or capacitive stylus used for mobile phones, tablets, graphics tablets or other objects which must be positioned in such a way they can be grasped in a simple and quick manner by a user to be used and can be arranged so as not to create encumbrance when no longer in use.

### STATE OF THE ART

Typically, a user often needs to have a small object readily available for use it for a limited period of time and to have to put this object away when it is no longer in use, so that the object does not represent an encumbrance for the user activities.

Think, for example, of a musician who plays a guitar or other stringed instruments, who, depending on musical needs, wishes to alternate certain moments, wherein it is necessary to use a plectrum to perform, for example, fast solos which would be complicated to perform by only using his/her fingers, and other moments when he/she wants to use only the hand fingers, for example to perform arpeggios with the “Fingerstyle” method (plucking the strings), or with the “Tapping” method (hitting the strings with the fingers) or use the guitar with the technique of a guitarist playing classical music.

Think also of a carpenter, a surveyor, or other technician, for example in the construction world, who must have a pencil readily available to mark on a piece of paper the measurement results, or to use a capacitive nib to write or draw on a mobile or tablet.

Typically, nowadays, the difficulty of a guitarist consists in the fact that the plectrum that is gripped between the thumb and forefinger of his hand often moves, rotates or, even worse, falls by plucking the guitar strings.

For this reason, there are plectrum holders available on the market where the guitarist may find a new plectrum available for using it.

However, these plectrum holders, which can be attached to microphone stands, or to the guitar itself, do not favour the fast and alternating exchange between the use of plectrum and the use of fingers only.

The Applicant of the present invention has found the need to realize a support device for a plectrum for a guitar, pencils or other similar objects which is not bulky, and which allows the user to readily grasp/store this object from/into the support device as needed.

### SUMMARY

The Applicant of the present invention has in fact surprisingly found that the technical problem encountered above can be solved in an effective and reliable way by means of an object supporting device, comprising a first element adapted to be fixed to a finger of a user's hand, and a second element adapted to be fixed to said first element and able to support said object.

Said first element comprises: a) a main body, b) at least one band provided with a first end fixed to said main body and a second free end, opposite to said first end, c) a fixing body fixed to said main body and provided with at least one seat, wherein each of said at least one seat is adapted to accommodate and lock in it said second free end of said corresponding at least one band, so that each of said at least one band, once fixed in the corresponding seat, forms a sort of a ring adapted to be wrapped around said finger.

Said first element further comprises an internally hollow body fixed to said main body arranged substantially along the longitudinal direction of one of said bands.

In this way, said internally hollow body is able to engage with a portion of said second element, as described below.

Once each of said at least one band has been fixed in the corresponding seat, the band itself forms a sort of ring suitable to be wrapped around the user's finger, in particular the thumb.

Furthermore, the object supported by the device of this invention can be made readily available to the user for its use.

According to a preferred embodiment, said object is a plectrum for a guitar or other string musical instrument, or a pencil or other small object that can be easily gripped by said user. For example, a small pencil can also be used for facilitating the job of music composer, for example at the piano, allowing the music composer to play and to have the pencil immediately available to write on the music pentagram.

According to a preferred embodiment, the length of said at least one band is adjustable according to the user's needs. For example, the portion in excess of the band, once fixed in the seat, can be cut with a pair of scissors so that there are no band portions creating unnecessary bulk.

According to a preferred embodiment, said first element comprises at least two bands arranged parallel to each other and wherein said fastening body includes two corresponding seats to accommodate and lock said two bands therein.

In this way, the two bands parallel to each other form a double ring, designed to wrap the user's finger, and to make the fixing of the device around the finger more stable.

According to a preferred embodiment, each of said at least one band has at least one edge with a toothed profile.

In this way, the toothed profile of said edge allows the user to adjust the ring around his/her finger.

According to a preferred embodiment, both edges of said at least one band has a toothed profile.

In this way, the toothed profile of both the band edges allows the ring (obtained from the two bands inserted in their respective seats), together with the grooves of the main body, to provide an even greater grip so as to be stably anchored to the thumb.

According to a preferred embodiment, said first element is made of elastic material.

In this way, said first element is able to deform under user pressure to be handled more easily by the user himself during the positioning of said first element around the user's finger. Furthermore, said first element, being elastic, is able to assume back its initial position when it is no longer subjected to deformation.

According to a preferred embodiment, said second element comprises an element having a substantially cylindrical shape able to be fixed to said internally hollow body of said first element.

According to a preferred embodiment, said substantially cylindrical shaped element has a diameter substantially equal to the diameter of said internally hollow body of said first element.

In this way, said substantially cylindrical element of the second element is able to be fixed on said internally hollow body of said first element, as it is a sort of continuation thereof.

According to a preferred embodiment, said substantially cylindrical element is provided with a screw, located at one of its ends.

In this way, said substantially cylindrical shaped element is able to be positioned on said internally hollow body of said first element as a sort of continuation thereof, with said screw placed on the opposite side of said internally hollow body. By tightening the screw, it is therefore possible to fix the substantially cylindrical element and the internally hollow body to each other.

According to a preferred embodiment, said screw is self-tapping and has a countersunk head.

In this way, the fastening between the two elements is improved.

According to a preferred embodiment, said screw has a triangular shaped head.

In this way, the fastening between the two elements is further improved.

According to a preferred embodiment, said screw has a length such that, once screwed, the head of the screw remains at the same height as the substantially cylindrical element.

In this way, the head of the screw does not protrude beyond the upper part of the substantially cylindrical-shaped element, thus avoiding the creation of an encumbrance that could be annoying for the user during the use of the object supported by the device of the present invention, such as when using a guitar plectrum.

According to a preferred embodiment, said second element also comprises a support element to support said object on it, such as for example a plectrum, a pencil or other small objects that can be used by the user.

According to a preferred embodiment, said support element has an elongated, substantially flat shape, provided with two surfaces arranged on the two opposite sides of a base support, and able to rotate of approximately 90°-150° around said substantially cylindrical element, which acts as a rotation fulcrum.

In this way, said support element is able to pass from a “working” position, wherein the object fixed on it is in a position that can be easily grasped by the user, to a “rest position”, wherein the object is in a position that does not create encumbrance for the user, and vice versa.

Therefore, when the user wants to use the object (for example a guitar plectrum) to perform for example solos that otherwise, without a plectrum, would be difficult to perform, he/she is able to grip the plectrum between the thumb and the index finger of his/her hand.

Conversely, when the user does not want to use the plectrum, for example because he/she wants to use his fingers for arpeggios or to use the guitar with the Fingerstyle or Tapping technique, the support element is rotated of about 90°-150° around said substantially cylindrical element of so that the plectrum remains in such a position as not to create an annoying bulk for the user's hand and fingers.

The object (for example, the plectrum) will be able to return again to a position to be used by the user by allowing said support element to rotate back of about 90°-150°, in the opposite direction.

According to a preferred embodiment, said object can be positioned on the support element in any position, preferably for example in the centre of the support element or, alternatively, at one of its ends, according to the user's needs.

According to a preferred embodiment, said object is fixed to said support element by means of a double-side adhesive.

In this way, the double-side adhesive allows an excellent seal for the object which therefore remains firmly fixed to said support element, preventing the object itself from slipping, moving or even falling during the support element rotation.

According to a preferred embodiment, said second element provided with said rotatable support element is positioned under the thumb or, alternatively, on the palm of the user's hand, according to the user's needs.

According to a preferred embodiment, the support element length can be adjusted according to the user's needs, possibly by cutting the portion in excess with a pair of scissors or similar.

According to a preferred embodiment, if said object is a small pencil or other slender object, said second element is provided with a pencil holder having a perforated half sphere shape, fixed to said support element.

In this way, the pencil can be inserted into said pencil holder when not used by the user. Further characteristics and advantages of the present invention will be better highlighted by examining the following detailed description of a preferred but not exclusive embodiment of the invention, illustrated by way of non-limiting example, with reference to the following figures wherein:

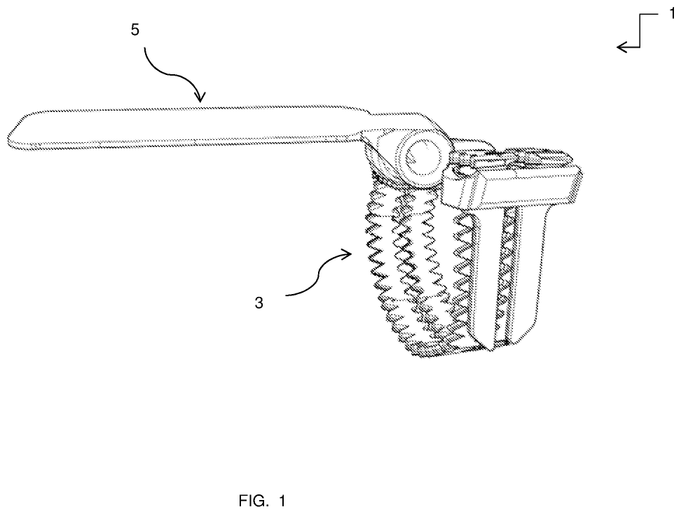

FIG. 1 shows a perspective view of an embodiment of the device of the present invention, wherein a first element and a second element fixed to each other are visible;

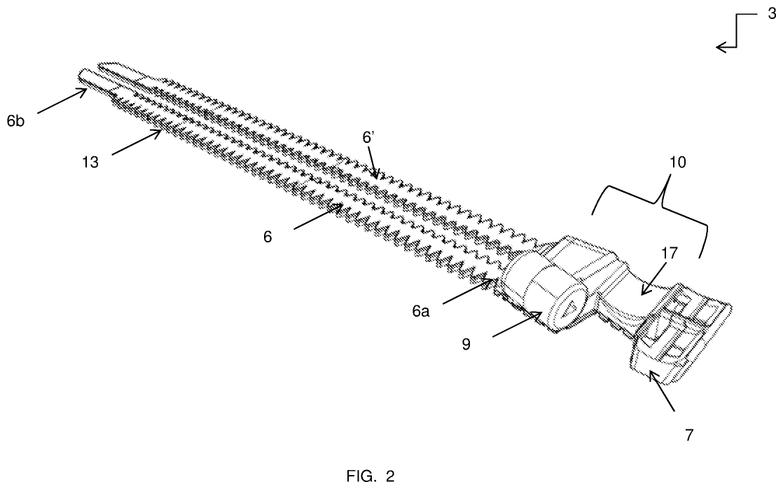

FIG. 2 shows in detail a perspective view of the first element of FIG. 1;

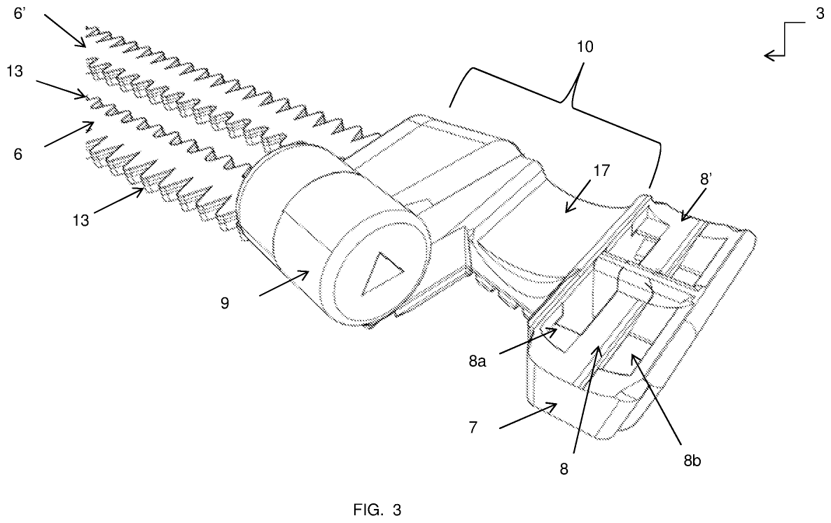

FIG. 3 shows a detail of the first element of FIG. 2;

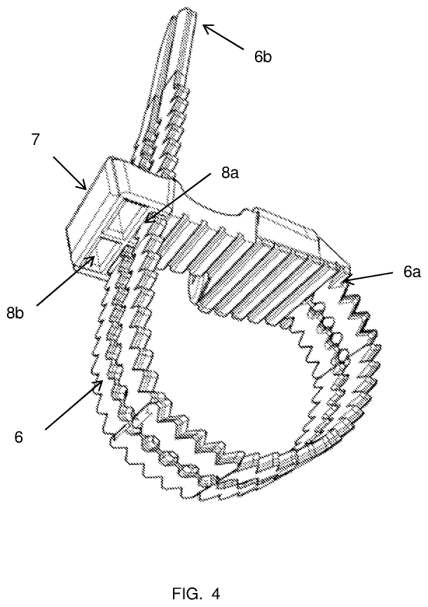

FIG. 4 shows a bottom view of the first element of FIG. 2 in a phase wherein the bands are inserted in the appropriate seats;

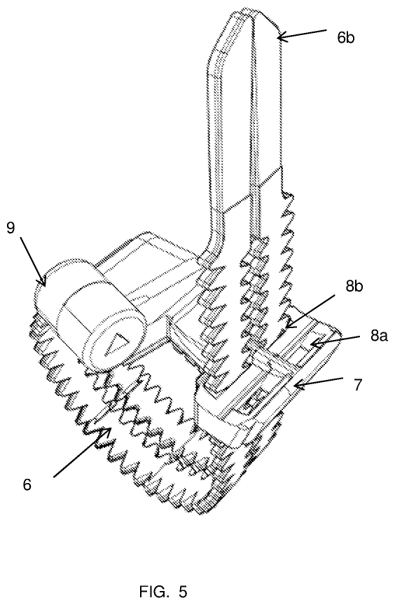

FIG. 5 shows a top view of the first element of FIG. 2 in a phase wherein the bands are inserted in the appropriate seats;

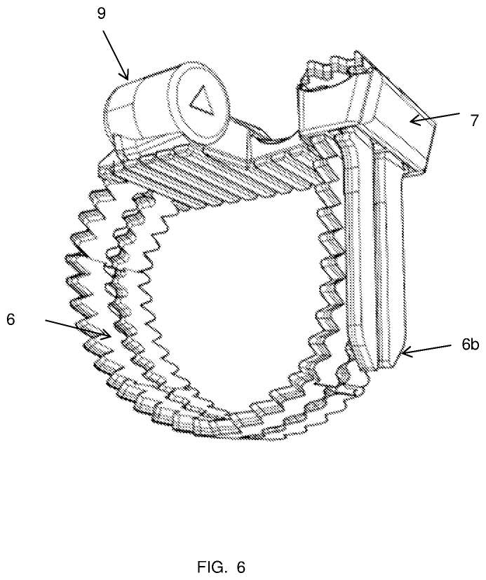

FIG. 6 shows a bottom view of the first element of FIG. 2 in a phase wherein the bands are fixed in the appropriate seats to form a ring;

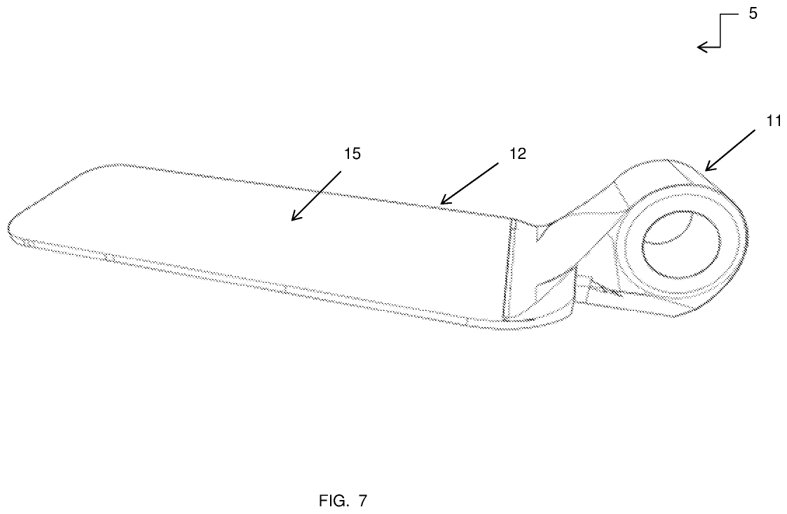

FIG. 7 shows in detail a perspective view of the second element of FIG. 1;

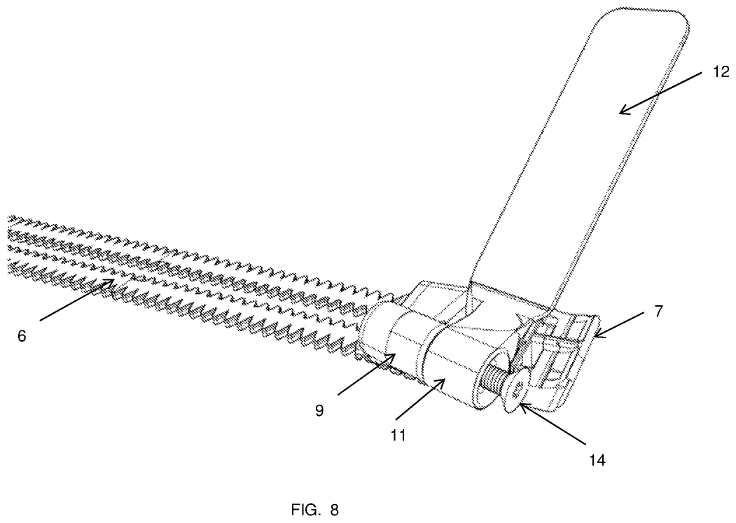

FIG. 8 shows a perspective view of a detail of the fastening of the second element of FIG. 7 to the first element of FIG. 2;

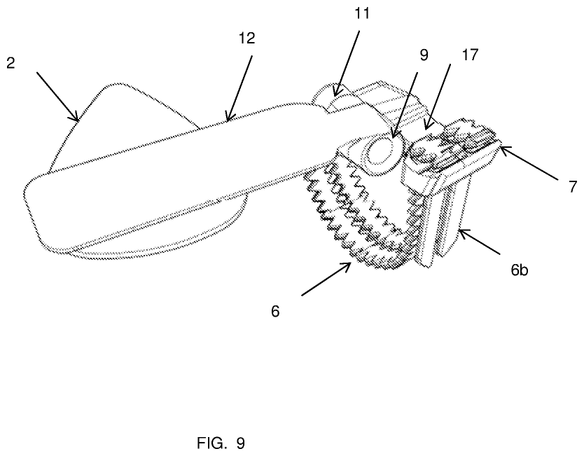

FIG. 9 shows a perspective view of the device of FIG. 1 wherein a plectrum fixed to the second element of FIG. 7 is visible in the position of use;

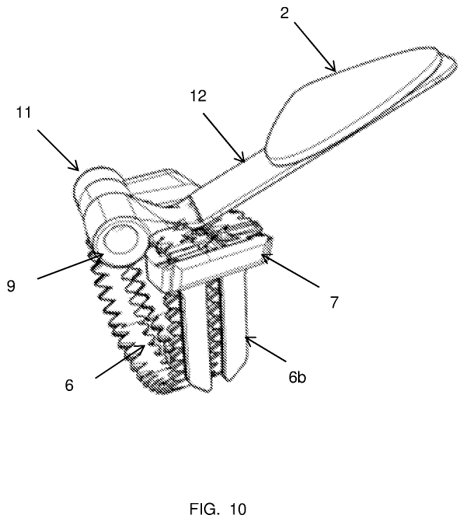

FIG. 10 shows a perspective view of the device of FIG. 1 wherein a plectrum fixed to the second element of FIG. 7 is visible in the rest position;

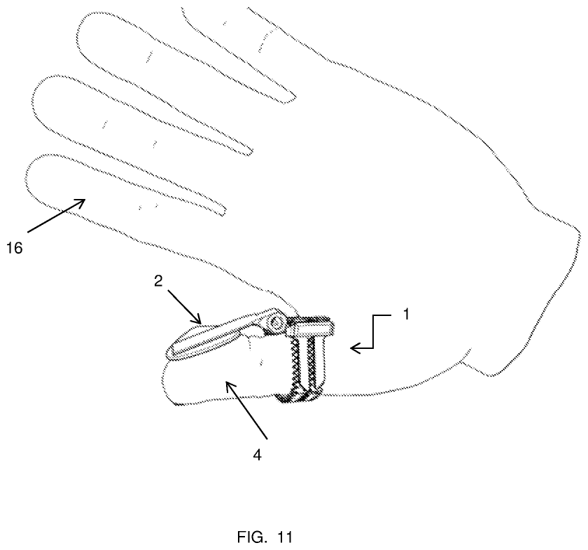

FIG. 11 shows the device of FIG. 9 fixed to the thumb of a user in the position of use;

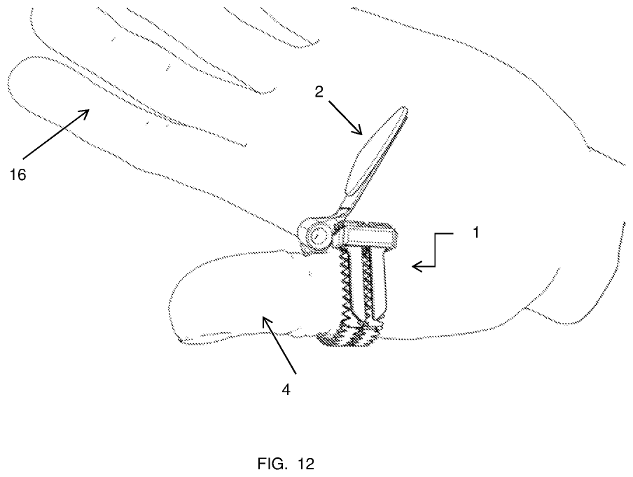

FIG. 12 shows the device of FIG. 10 fixed to the thumb of a user in the rest position;

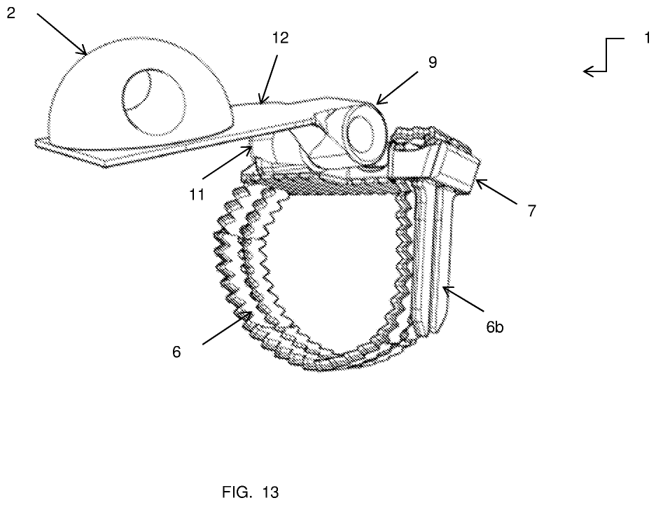

FIG. 13 shows a perspective view of the device of FIG. 1 wherein a pencil holder fixed to the second element of FIG. 7 is visible in the position of use;

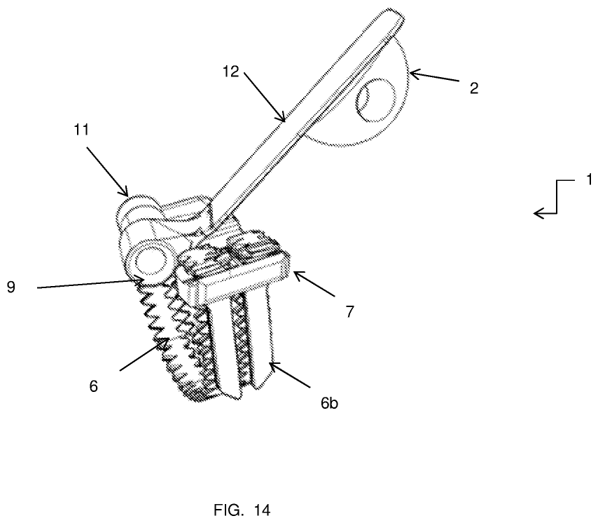

FIG. 14 shows a perspective view of the device of FIG. 1 wherein a pencil holder fixed to the second element of FIG. 7 is visible in the rest position;

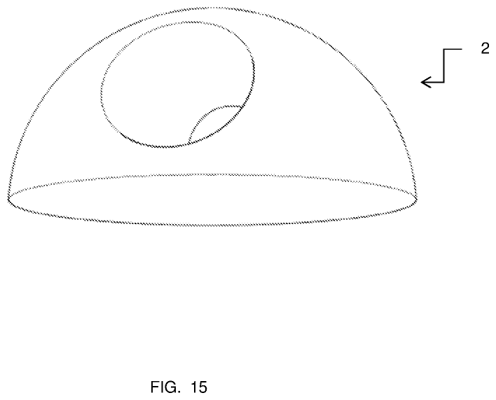

FIG. 15 shows in detail the pencil holder of FIG. 13;

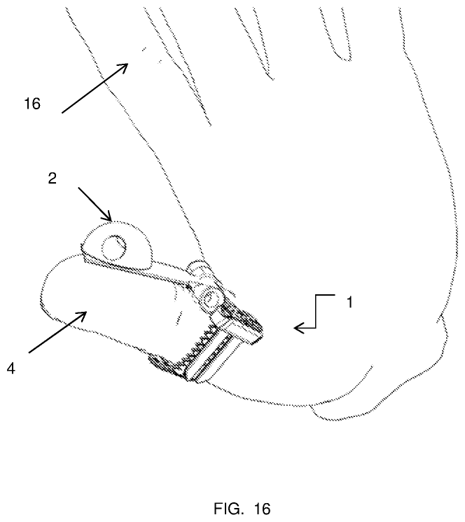

FIG. 16 shows the device of FIG. 13 fixed to the thumb of a user in the position of use;

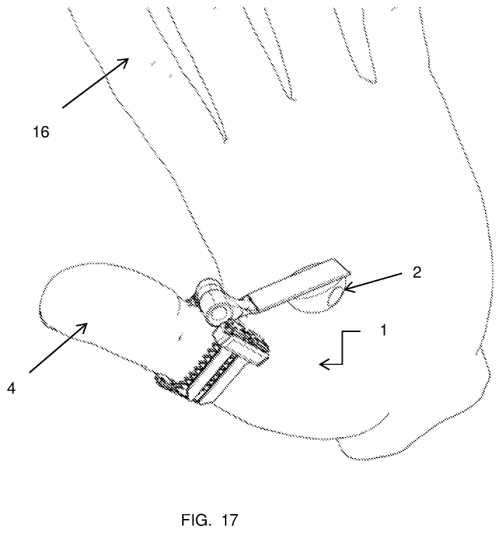

FIG. 17 shows the device of FIG. 14 fixed to the thumb of a user in the rest position.

### DETAILED DESCRIPTION

The following detailed description refers to particular embodiments of the present invention, without limiting their content.

With reference to FIGS. 1-12, a first embodiment of an object supporting device 1 for supporting objects 2 of the present invention is described. In this particular case, the object 2 is a plectrum for a guitar or for other string instrument.

The device 1 (FIG. 1) comprises a first element 3 (shown in FIGS. 2-6), and a second element 5 (shown in FIG. 7); the second element 5 is fixed to the first element 3 (FIGS. 8-10) and the whole (3, 5) is fixed to the user thumb 4 (see FIGS. 11 and 12).

In detail (FIG. 2), the first element 3 comprises: a) a main body 10, b) two bands 6,6′ arranged parallel to each other, wherein each band 6,6′ is provided with a first end 6a fixed to the main body 10 and a second free end 6b, opposite the first end 6a, and c) a fixing body 7 fixed to the main body 10 and provided with a pair of seats 8,8′ (FIG. 3). The seats 8,8′ are structured in such a way as to accommodate and lock in them the second free end 6b of the corresponding band 6,6′. In detail, each seat 8,8′ is provided with a first portion 8a which allows a first passage through it of the free end 6b of the band 6,6′ (FIG. 4 seen from below and FIG. 5 seen from above), and of a second portion 8b which allows the second free end 6b of the band 6,6′ to pass through it (FIG. 6) to firmly fix the band 6,6′ to the main body 10 of the first element 3.

In this way, both bands 6,6′, once fixed in the corresponding seats 8,8′, form a sort of ring suitable to be wrapped around the user's thumb 4 (FIGS. 11 and 12).

Both the edges 13 of each band 6,6′ has a toothed profile; this allows for an even better grip around thumb 4.

The length of each 6,6′ band is adjustable according to the user's needs; it is therefore possible to cut off the parts in excess.

The first element 3 of the device 1 of the present invention further comprises an internally hollow body 9, substantially cylindrical in shape, fixed to the main body 10 and arranged substantially along the longitudinal direction of the two parallel bands 6,6′ (FIGS. 2 and 3).

The second element 5 of the device 1 of the present invention (FIG. 7) comprises a substantially cylindrical element 11 and a support element 12 for supporting the guitar plectrum 2 thereon (FIG. 9).

In particular, the substantially cylindrical element 11 is fixed to the internally hollow body 9 of the first element 3 (FIG. 8). In fact, the substantially cylindrical element 11 of the second element 5 and the internally hollow body 9 of the first element 3 have substantially the same diameter. This allows the two elements 9, 11 to be fixed one on top of the other; the substantially cylindrical element 11 is provided with a screw 14, placed on the opposite side of the internally hollow body 9. By tightening the screw 14, it is therefore possible to fix the substantially cylindrical element 11 and the body internally cable 9 one another. The screw 14 is self-tapping and has a countersunk head, so as to facilitate fastening between the two elements; moreover, the screw 14 has a triangular-shaped head, so as to further facilitate the fastening between the two elements. Furthermore, the screw 14 has such a length that, once screwed in, the head of the screw 14 remains at the same height as the substantially cylindrical element 11. In this way, the head of the screw 14 does not protrude beyond the upper part of the substantially cylindrical element 11, thus avoiding creating a bulk that could be annoying for the user when using the plectrum 2.

The support element 12 is slender, substantially flat, provided with two surfaces arranged on the two opposite sides of a base 15, and capable of rotating by 150° around the substantially cylindrical element 11, which acts as a rotation fulcrum. The plectrum 2 can therefore pass from a “working” position, wherein it can be easily grasped by the user and held between the thumb 4 and the index finger 16 (FIGS. 9 and 11), to a “rest” position, wherein the plectrum 2 is in such a position as not to create encumbrance for the user when not in use, for example on the palm of the user's hand (FIGS. 10 and 12), and vice versa.

Therefore, when the user wants to use the plectrum 2 to perform, for example, solos that would otherwise be difficult to perform without a plectrum, he/she is able to grip the plectrum 2 between the thumb 4 and the index finger 16 of his/her hand.

Conversely, when the user does not want to use the plectrum 2, for example because he/she wishes to use his fingers for arpeggios or to use the guitar with the guitarist playing classical music technique, the support element 12 is rotated by 150° around the substantially cylindrical element 11 so that the plectrum 2 remains in such a position as not to create an annoying bulk for the user's hand and fingers. Subsequently, the plectrum 2 can return back to the working position, allowing the support element 12 to perform a new rotation of 150°, in the opposite direction.

The plectrum 2 is fixed to the support element 12 by means of a double-side adhesive (not shown in the figures); this allows an excellent seal for the plectrum 2 which therefore remains firmly fixed to the support element 12, preventing the plectrum 2 itself from slipping, moving or even falling during the support element rotation.

In FIGS. 9 and 10, the plectrum 2 is fixed on the support element 12 so as to occupy the area furthest away from the substantially cylindrical element 11. However, the user can decide each time which is the most suitable point for fixing the plectrum 2 to the support element 12.

Referring again to FIG. 2 (and in detail to FIG. 3), the main body 10 of the first element 3 of the device 1 of the present invention has a portion 17, positioned between the internally hollow body 9 and the fixing body 7. This portion 17 of the main body 10 has a substantially flat or slightly curved shape so as to allow a portion of the flat base 15 of the support element 12 of the second element 5 to rest on it. Furthermore, the portion 17 of the main body 10 has a reduced length such as to allow the substantially cylindrical element 11 positioned at the end of the support element 12 to be positioned exactly in correspondence with the internally hollow body 9, to be fixed to it by means of the screw 14 (FIG. 8). This portion 17 of the main body 10 also has a slightly lower height than the fixing body 7 placed next to it (it is in practice lowered with respect to it), as can be seen in FIGS. 2 and 3, so as to facilitate the rotation of 150° of the support element 12 around the substantially cylindrical element 11 which acts as a rotation fulcrum (FIGS. 9 and 10).

All the components that form the first element 3 (bands 6,6′, fixing body 7, seats 8,8′, internally hollow body 9, portion 17, etc.) are made of elastic material. In this way, each component of the first element 3 is able to deform under the user pressure to be more easily handled by the user during the fixing of the bands 6,6′ in their seats 8,8′ and during the positioning of the first element 3 around the user thumb 4. Furthermore, the first element 3, being elastic, is able to assume its initial position again when it is no longer subjected to deformation.

With reference to FIGS. 13-17, a second embodiment of a support device 1 for objects 2 of the present invention is described. In this particular case, the object 2 is a pencil holder, useful for housing a ready-to-use pencil for a carpenter, a surveyor, or other technician, for example in the construction world, who must have a pencil readily available for mark on a sheet of paper the measurement results, or a capacitive stylus to be used for mobile phones or tablets. A small pencil can also be used to facilitate music composers, for example at the piano, to play and to have the pencil immediately available to write on the pentagram.

In FIG. 13, the pencil holder 2 is fixed by means of a double-side adhesive to the support element 12 so that the pencil is readily available to the user for its use; vice versa, FIG. 14 shows the pencil holder 2 fixed to the support element 12 so that the pencil is in the rest position (non-use); FIG. 15 shows in detail the pencil holder of FIG. 13, in the shape of a perforated half sphere. In this way, the pencil can be inserted into the pencil holder 2 when not in use by the user.

Similarly to what has been seen above with reference to FIGS. 11 and 12 (wherein the device 1 is fixed to the user's thumb 4 and the object 2 fixed to the device 1 is a plectrum 2, respectively, in the “working” and “rest” position), FIGS. 16 and 17 show the same device 1 fixed to the user's thumb 4, but in this case the object 2 is a pencil holder 2.

Of course, many modifications and variations of the described preferred embodiments will be apparent to those skilled in the art, still remaining within the scope of the invention.

Therefore, the present invention is not limited to the preferred embodiments described, illustrated only by way of non-limiting example, but is defined by the following claims.

The present application claims the benefit of priority to IT Application No. 102021000026420, filed Oct. 14, 2021, the entire contents of which are hereby incorporated by reference.

1. An object supporting device (1), comprising a first element (3) adapted to be fixed to a finger (4) of a user's hand, and a second element (5) adapted to be fixed to said first element (3) and able to support said object (2),
wherein said first element (3) comprises: a) a main body (10), b) at least one band (6) provided with a first end (6a) fixed to said main body (10) and a second free end (6b), opposite said first end (6a), c) a fixing body (7) fixed to said main body (10) and provided with at least one seat (8), wherein each of said at least one seat (8) is adapted to receive and lock in it said second free end (6b) of said corresponding at least one band (6), so that each of said at least one band (6), once fixed in the corresponding seat (8), forms a sort of a ring adapted to be wrapped around said finger (4),
and wherein said first element (3) further comprises an internally hollow body (9) fixed to said main body (10) arranged substantially along the longitudinal direction of one of said bands (6).

2. Device (1) according to claim 1, wherein said first element (3) comprises at least two bands (6) arranged parallel to each other and wherein said fastening body (7) comprises two corresponding seats (8) to accommodate and lock said two bands (6) therein.

3. Device (1) according to claim 1, wherein said at least one band (6) has a toothed profile (13).

4. Device (1) according to claim 1, wherein said first element (3) is made of elastic material.

5. Device (1) according to claim 1, wherein said second element (5) comprises an element having a substantially cylindrical shape (11) adapted to be fixed to said internally hollow body (9) of said first element (3).

6. Device (1) according to claim 1, wherein said second element (5) comprises an element having a substantially cylindrical shape (11) adapted to be fixed to said internally hollow body (9) of said first element (3); and wherein said second element (5) further comprises a support element (12) for supporting said object (2) thereon, wherein said support element (12) has an elongated, substantially flat shape, provided with two surfaces arranged on the two opposite sides of a base support (15), and able to rotate of approximately 90°-150° around said substantially cylindrical element (11) so that said object (2) switches from a position where it is facing up to a position where it is facing down, and vice versa.

7. Device (1) according to claim 6, wherein said object (2) is fixed to said support element (12) by means of a double-side adhesive.

8. Device (1) according to claim 1, wherein said object (2) is a plectrum, pencil or other object that can be easily gripped by said user.

9. Device (1) according to claim 2, wherein each of said at least one band (6) has a toothed profile (13).
